(19) United States
(12) Patent Application Publication
(10) Pub. No.: US 2020/0031352 A1
(43) Pub. Date: Jan. 30, 2020

(54) APPARATUS AND METHOD FOR ASSISTING DRIVING VEHICLE

(71) Applicant: DENSO CORPORATION, Kariya-city (JP)

(72) Inventors: Ryo TAKAKI, Kariya-city (JP); Takuya TAKAYAMA, Kariya-city (JP)

(21) Appl. No.: 16/524,466

(22) Filed: Jul. 29, 2019

(30) Foreign Application Priority Data
Jul. 30, 2018 (JP) 2018-142971

(51) Int. Cl. B60W 30/18; B60W 40/02; B60W 50/04; B60W 50/02

(52) U.S. Cl. CPC B60W 30/18; B60W 40/02; B60W 50/045; B60W 50/0225; B60W 2550/14; B60W 2420/42; B60W 2520/28; B60W 2520/14; B60W 2520/105; B60W 2420/52; B60W 2420/54; B60W 2540/18

(57) ABSTRACT

In an apparatus for assisting driving a vehicle, an error calculation unit calculates errors in first information representing a driving state of the vehicle based on the first information and second information including at least one of surroundings information and external location information of the vehicle. An error correction unit corrects for the errors in the first information. If error correction performed by the error correction unit is completed, a location estimation unit estimates a location of the vehicle based on the first information corrected for the errors. A driving assistance unit performs driving assistance for the vehicle based on the location of the vehicle estimated by the location estimation unit. If error correction performed by the error correction unit is completed, a process change unit changes a process of a specific type of driving assistance performed by the driving assistance unit.

### CROSS-REFERENCE TO RELATED APPLICATION

This application is based on and claims the benefit of priority from earlier Japanese Patent Application No. 2018-142971 filed on Jul. 30, 2018, the description of which is incorporated herein by reference.

### BACKGROUND

### Technical Field

The present disclosure relates to a driving assistance apparatus that estimates a location of an own vehicle, and based on the estimated location, perform vehicle driving assistance.

### Related Art

Driving assistance apparatuses are known that estimate a location of an own vehicle based on sensor readings from a wheel speed sensor, a yaw rate sensor and the like, and based on the estimated location of the own vehicle, perform own-vehicle driving assistance.

### BRIEF DESCRIPTION OF THE DRAWINGS

In the accompanying drawings:

FIG. 1 is a block diagram of a driving assistance apparatus mounted to a vehicle according to a first embodiment;

FIG. 2 is a flowchart of collision avoidance control according to the first embodiment;

FIG. 3 is a flowchart of setting a process of driving assistance according to the first embodiment;

FIG. 4 is an illustration of error correction of a wheel speed according to the first embodiment;

FIG. 5 is an example relationship between actuation timing and vehicle speed in each process of driving assistance according to the first embodiment;

FIG. 6A to 6C are an illustration of reference and actuation timings according to the first embodiment;

FIG. 7 is a flowchart of setting a process of driving assistance according to a second embodiment;

FIG. 8 is an illustration of error correction of a yaw rate according to the second embodiment;

FIG. 9 is a flowchart of setting a process of driving assistance according to a third embodiment;

FIG. 10 is an example table of degrees of change in a process of driving assistance according to the third embodiment;

FIG. 11 is an example relationship between the degree of change in a process of driving assistance and the vehicle speed;

FIG. 12 is an example relationship between the degree of change in a process of driving assistance and the vehicle speed;

FIG. 13 is an example relationship between the degree of change in a process of driving assistance and the curve radius;

FIG. 14 is a flowchart of setting a process of driving assistance according to a fourth embodiment;

FIG. 15 is an example table of degrees of change in a process of driving assistance according to the fourth embodiment;

FIG. 16 is an example relationship between the degree of change in a process of each type of driving assistance and the curve radius or the vehicle speed;

FIG. 17 is a flowchart of lane change control according to a modification;

FIG. 18A is an illustration of lane change timing in an active mode; and

FIG. 18B is an illustration of lane change timing in a passive mode.

### DESCRIPTION OF SPECIFIC EMBODIMENT

An example driving assistance apparatus, as disclosed in Japanese Patent No. 5412985, calculates a curvature of a travel trajectory of the own vehicle based on sensor readings from the wheel speed sensor, the turning angle sensor and the like, and based on the calculated curvature, estimates a location of the own vehicle and performs automated parking. The term “own vehicle” as used herein indicates a vehicle carrying the driving assistance apparatus.

Errors in the sensor readings from the wheel speed sensor, the turning angle sensor and the like may cause accuracy lowering of the location of the own vehicle estimated using these sensor readings. For example, as disclosed in Japanese Patent No. 5412985 where a location of the own vehicle is estimated based on sensor readings from the wheel speed sensor, a deviation of a tire diameter from its assumed value due to a low air pressure of the tire or the like may lead to accuracy lowering of the location of the own vehicle. Reduced accuracy of the location of the own vehicle may make it difficult to properly perform driving assistance.

In view of the above, it is desired to have a driving assistance apparatus that can ensure the accuracy of an estimated location of an own vehicle, thereby properly performing driving assistance.

Hereinafter, exemplary embodiments of the present disclosure will be described in detail with reference to the accompanying drawings, in which like reference numerals refer to like or similar elements regardless of reference numerals and duplicated description thereof will be omitted.

### First Embodiment

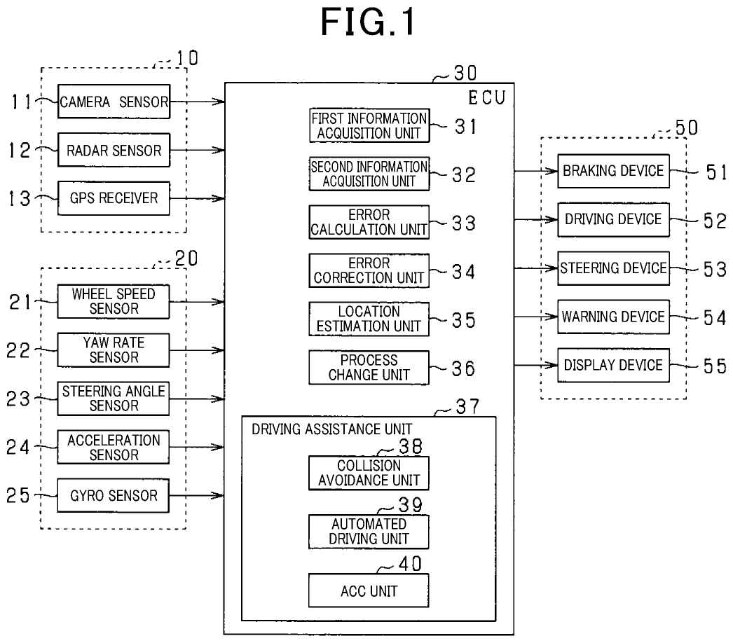

FIG. 1 illustrates a driving assistance system mounted to a vehicle according to a first embodiment of the present disclosure. The driving assistance system includes a location information acquisition unit 10, a driving state sense unit 20, an electronic control unit (ECU) 30, and a controlled device unit 50. The vehicle carrying the driving assistance system is hereinafter referred to as an own vehicle.

The location information acquisition unit 10 includes a camera 11, a radar sensor 12, and a global positioning system (GPS) receiver 13. The camera 11 and the radar sensor 12 are example surroundings monitoring devices that acquire surroundings information which is information about surroundings of the own vehicle. Other example surroundings monitoring devices may include sensors that transmit probe waves, such as an ultrasonic sensor, a light detection and ranging (LIDAR) sensing device and the like. The GPS receiver 13 is an example of the global navigation satellite system (GNSS) receiver, which receives positioning signals from a satellite positioning system using satellites to determine a current location.

The camera sensor 11 may be a monocular camera, such as a charge-coupled device (CCD) camera, a complementary metal-oxide semiconductor (CMOS) image sensor, a near-infrared camera or the like, or may be a stereo camera. The camera sensor 11 may include only one camera or a plurality of cameras. The camera sensor 11 may be disposed near a vehicle-widthwise center at a position of a predetermined height to capture, from an overhead perspective, images of an area that horizontally spans a pre-defined range of angles from a forward looking imaging axis of the camera. The camera sensor 11 captures feature points indicative of presence of an object in the images. More specifically, the camera sensor 11 extracts edge points based on brightness information of captured images, applies a Hough transform or the like to the extracted edge points. In the Hough transform, feature points to be extracted include points on a line along which a plurality of edge points reside and points at which two lines intersect. The camera 11 outputs to the ECU 30 sensing information including a sequence of captured images.

The radar sensor 12 is a well-known millimeter-wave radar that transmits radio-frequency signals in a millimeter waveband as transmit waves. The radar sensor 12 may include only one millimeter-wave radar or may include a plurality of millimeter-wave radars. The radar sensor 12 may be installed at the front end of the own vehicle and detect locations of objects present within a detection angle range. More specifically, the radar sensor 12 transmits probe waves every predetermined time interval and receives reflected waves of the probe waves via a plurality of antennas, and calculate a distance between the own vehicle and the object based on probe wave transmission times and reflected wave reception times. The radar sensor 12 calculates a relative speed of the object relative to the own vehicle based on frequency changes caused by the doppler effect. In addition, the radar sensor 12 calculates an azimuth angle of the object based on phase differences between the reflected waves received by the plurality of antennas. Once the location and the azimuth of the object are successfully calculated, a relative position of the object to the own vehicle can be determined.

A millimeter-wave radar, such as a radar sensor 12 or the like, sensors, such as the sonar, the LIDAR and the like, which transmit probe waves, sequentially output to the ECU 30 sensing information including results of scanning based on received signals acquired upon receipt of reflected waves from obstacles.

The various surroundings monitoring devices set forth above may be configured to detect not only objects ahead of the own vehicle, but also objects behind and beside the own vehicle, and use results of detection as location information. An object to be monitored may be changed depending on a type of each surroundings monitoring device. For example, preferably, when the camera sensor 11 is used, stationary objects, such as road signs and buildings, may be monitored. When the radar sensor 12 is used, objects having large reflected laser power therefrom may be monitored. The surroundings monitoring devices to be used may be selected depending on a type, a location, or a movement speed of an object to be monitored.

The GPS receiver 13, which is an example of the GNSS receiver, is configured to receive positioning signals from the satellite positioning system to determine a current position using artificial satellites.

The GPS receiver 13 receives GPS signals from the GPS satellites and calculates own-vehicle location information based on the GPS signals. The GPS receiver 13 receives positioning signals every predetermined time interval. The GPS receiver 13 can calculate own-vehicle location information based on the received positioning signals and the like. The GPS receiver 13 sequentially receiving the positioning signals enables sequentially determining a location of the own vehicle.

The location information acquisition unit 10 enables detecting objects around the own vehicle or receiving signals from the outside of the own vehicle, which enables acquiring surroundings information and location information of the own vehicle. The ECU 30 acquires second information including the surroundings information and the location information of the own vehicle acquired by the location information acquisition unit 10. The location information acquisition unit 10 is not limited to the surroundings monitoring devices or the GNSS receiver as set forth above. The location information acquisition unit 10 may be any device capable of acquiring the surroundings information and the location information of the own vehicle.

The driving state sense unit 20 includes a wheel speed sensor 21, a yaw rate sensor 22, a steering angle sensor 23, an acceleration sensor 24, and a gyro sensor 25. The driving state sense unit 20 is mounted to a vehicle and formed of sensors that can detect driving information including various parameters indicative of a driving state of the own vehicle, such as a wheel speed, a yaw rate, a steering angle, a speed, an acceleration, a rotation angle, a speed of angular rotation. The ECU 30 acquires first information including sensor readings from the driving state sense unit 20.

The wheel speed sensor 21 may preferably be installed on each one of the four wheels although the wheel speed sensor 21 does not have to be installed on each one of the four wheels. The wheel speed sensor 21 may be attached to a wheel part and output to the ECU 30 a wheel speed signal in response to a wheel speed of the own vehicle. In the case where the wheel speed sensor 21 is installed on plural ones of the four wheels, an average over or a mean between a plurality of sensor readings may be used as first information. For example, in the case where the wheel speed sensor 21 is installed on each one of the four wheels, the second highest sensor reading may be used as first information.

Any number of yaw rate sensors 22 may be installed in the own vehicle. In the case where only one yaw rate sensor 22 is installed, the yaw rate sensor 22 may be installed in the middle position of the own vehicle to output to the ECU 30 a yaw rate signal in response to a rate of change in an amount of steering of the own vehicle. In the case where a plural number of yaw rate sensors 22 are installed, an average over or a mean between a plurality of sensor readings may be used as first information. In such a case, sensor readings may be weighted.

The steering angle sensor 23 may be attached to a steering rod of the own vehicle and output to the ECU 30 a steering angle signal in response to a steering angle generated by the driver operating the steering wheel. The acceleration sensor 24 detects and outputs to the ECU 30 a steering angle around each of mutually orthogonal three axes defined at center of the own vehicle. The acceleration sensor 24 may be referred to as a G-sensor. The gyro sensor 25 detects a rotation angle around each of mutually orthogonal three axes defined at center of the own vehicle and outputs to the ECU 30 a rotation angle signal.

The driving state sense unit 20 enables acquiring one or more types of driving information of the own vehicle. The driving state sense unit 20 may include any sensors configured to acquire driving information representing a driving state of the own vehicle, but is not limited to including sensors 21 through 25.

The controlled device unit 50 includes a braking device 51, a driving device 52, a steering device 53, a warning device 54, and a display device 55. The controlled device unit 50 operates in response to commands from the ECU 30 and manual inputs from the driver of the own vehicle. The manual inputs from the driver may be input to the controlled device unit 50 as control commands after being processed by the ECU 30.

The braking device 51 is configured to brake the own vehicle and controlled by driver's braking operations and commands from the driving assistance unit 37 of the ECU 30. The ECU 30 may have braking functions for collision avoidance or pre-crash mitigation, such as a braking assistance function for enhancing and assisting braking force generated by driver's braking operations and automated braking function which does not need the driver's braking operations. The braking device 51 can perform braking control based on control commands from the ECU 30.

The driving device 52 is configured to drive the own vehicle. The driving device 52 is controlled by driver's accelerating operations or commands from the driving assistance unit 37 of the ECU 30. More specifically, the driving device 52 may include, but is not limited to, a driving source, such as an internal-combustion engine, a motor, a rechargeable battery or the like, and its associated mechanisms. The ECU 30 has a function of automatically controlling the driving device 52 in response to a travel plan and a vehicle state of the own vehicle.

The steering device 53 is configured to steer the own vehicle. The steering device 53 is controlled by driver's steering operations or commands from the driving assistance unit 37 of the ECU 30. The ECU 30 has a function of automatically controlling the steering device 53 for collision avoidance and lane changes.

The warning device 54 is configured to provide an audible notification to the driver or the like. The warning device 54 may be a speaker, a buzzer, or the like installed in a passenger compartment of the own vehicle. The warning device 54 outputs an audible alarm or the like in response to a control command from the ECU 30 to notify the driver that the own vehicle is in danger of colliding with an object.

The display device 55 is configured to provide visual notifications to the driver or the like of the own vehicle. The display device 55 may include a display and indicators installed in a passenger compartment of the own vehicle. The display device 55 displays warning or alert messages in response to control commands from the ECU 30, thereby notifying the driver of danger of colliding with an object.

The controlled device unit 50 may include devices controlled by the ECU 30, other than the braking device 51, the driving device 52, the steering device 53, the warning device 54, and the display device 55. For example, the controlled device unit 50 may include a safeguard device for ensuring safety of the driver of the own vehicle. More specifically, the safeguard device may be a seat belt device installed at each seat, including a pretensioner mechanism for retraction of a seat belt of the seat. The seat belt device performs retraction of the seat belt and its preliminary action in response to a control command from the ECU 30. The pretensioner mechanism retracting the seat belt to remove belt slack enables reliably securing an occupant, such as the driver, to the seat, thereby protecting the occupant.

The ECU 30 includes, as functional blocks, a first information acquisition unit 31, a second information acquisition unit 32, an error calculation unit 33, an error correction unit 34, a location estimation unit 35, a process change unit 36, and a driving assistance unit 37. The ECU 30 may be configured as a microcomputer including a central processing unit (CPU), a memory as a collection of a read-only memory (ROM), a random-access memory (RAM), and an input/output interface (I/O). Functions of these blocks, as described later in detail, may be implemented by the CPU executing computer programs stored in the ROM or the like. This enables the ECU 30 to serve as the driving assistance apparatus that generates and outputs control commands to the controlled device unit 50 based on information acquired from the location information acquisition unit 10 and the driving state sense unit 20, thereby performing own-vehicle driving assistance.

Functions of the ECU 30 may be implemented by software only, hardware only, or a combination thereof. For example, when these functions are provided by an electronic circuit which is hardware, the electronic circuit can be provided by a digital circuit including many logic circuits, an analog circuit, or a combination thereof.

The first information acquisition unit 31 is configured to acquire, as first information, driving information representing a driving state of the own vehicle. For example, the first information acquisition unit 31 may acquire, as first information, sensor readings, such as a wheel speed, a yaw rate, a steering angle and the like, from the driving state sense unit 20. The first information may include statistically processed versions of sensor readings from the driving state sense unit 20. For example, the first information acquisition unit 31 may acquire and statistically process sensor readings from the wheel speed sensor 21 and the yaw rate sensor 22 and use statistically processed versions of the wheel speed and the yaw rate as first location information. Techniques for statistically processing such sensor readings may include known techniques, such as Simultaneous Localization and Mapping (SLAM) and Structure from Motion (SfM).

The second information acquisition unit 32 is configured to acquire, as second information, surroundings information or location information of the own vehicle acquired from the location information acquisition unit 10. The second information is information about the own vehicle that is acquired not based on driving states of the own vehicle. A movement, an orientation, a location of the own vehicle on a road surface, and a distance between the own vehicle and a vehicle other than the own vehicle can be directly measured based on the second information. For example, a location of the own vehicle can be calculated by at least one surroundings monitoring device calculating a location of the own vehicle relative to a specific stationary object that can be used as a landmark. The second information acquisition unit 32 may acquire a location, a movement speed and the like of an object to be monitored in surroundings monitoring, together with the surroundings information or the location information of the own vehicle, from the location information acquisition unit 10.

The error calculation unit 33 calculates an error in the first information based on the first information acquired by the first information acquisition unit 31 and the second information acquired by the second information acquisition unit 32. For example, the error calculation unit 33 may compare a change in the first information and a change in the second information within a predetermined period of time during traveling of the own vehicle, thereby calculating as a difference of the first information from the second information as an error in the first information. The error may be calculated each time the first information and second information are sequentially acquired, or may be calculated by performing statistical processing or filtering on the first and second information acquired within a certain period of time.

The error calculation unit 33 may be configured to calculate physical quantiles relating to the first information based on the second information and calculate an error in the first information by comparing the calculated physical quantiles with the first information. For example, the error calculation unit 33 may calculate a wheel speed of the own vehicle based on a change in a distance between an object detected by the camera sensor 11 and the own vehicle, and calculate a difference between the calculated wheel speed of the own vehicle and the sensor reading from the wheel speed sensor 21 as an error in the first information. Alternatively, the error calculation unit 33 may represent the first information and the second information in terms of their respective specific physical quantities (for example, a vehicle speed of the own vehicle and the like) and compare the physical quantities to calculate an error in the first information.

The error calculation unit 33 may be configured to determine whether or not error correction has been completed. For example, the error calculation unit 33 may be configured to sequentially calculate errors, and if the calculated values of errors are stable (for example, if the calculated values fall within a predetermined error rage), determine that error correction has been completed. Alternatively, the error calculation unit 33 may be configured to, a variance of calculated errors falls within a predetermined range, determine that error correction has been completed.

The error calculation unit 33 may be configured to determine whether to calculate errors in the first information in response to a driving state of the own vehicle. For example, the error calculation unit 33 may be configured to, only if the own vehicle is considered as being traveling straight, decide to calculate errors in sensor readings from the wheel speed sensor 21 and the yaw rate sensor 22. For example, if a sensor reading of the steering angle acquired by the steering angle sensor 23 is substantially constant and a variation in sensor reading of the yaw rate acquired by the yaw rate sensor 22 is small, the own vehicle may be considered as being traveling straight.

The error calculation unit 33 may be configured to, if the speed of the own vehicle is substantially constant, that is, if the acceleration of the own vehicle is about zero, calculate errors in the first information. The speed of the own vehicle can be calculated based on sensor readings from the wheel speed sensor 21. The acceleration of the own vehicle may be calculated from changes in speed of the own vehicle (for example, changes in sensor reading from the wheel speed sensor 21), or may be calculated from sensor readings from the acceleration sensor 24 or the presence or absence of a driver's acceleration maneuver.

When the sensor readings from the surroundings monitoring devices are used as the second information, the error calculation unit 33 may determine whether to use the second information for error calculation and or error correction of the first information, in response to a location or a movement speed of an object to be monitored. For example, in the case of a distant location or a high movement speed of the object, the second information may not be used for error calculation or error correction of the first information. Only in the case of a near location or a low movement speed of the object, the second information may be used for error calculation or error correction of the first information. There is a concern about accuracy lowering of object detection in the case of a distant location or a high movement speed of the object. In such a case, not using the second information for error calculation and/or error correction of the first information can ensure the accuracy of the first information.

The error calculation unit 33 may calculate a location of the own vehicle, a vehicle speed, a rotational speed using positioning signals received by the GPS receiver 13 as second information, compare the calculated values with sensor readings from the driving state sense unit 20, such as the wheel speed sensor 21, the yaw rate sensor 22 and the like, thereby calculating the errors in the first information.

The error calculation unit 33 may use either or both of surroundings information from the surroundings monitoring devices, such as the camera sensor 11, the radar sensor 12 and the like, and location information from the GNSS receiver, such as the GPS receiver 13, depending on situations. When using both the surroundings information and the location information, the error calculation unit 33 may use an average of location information acquired from both the surroundings information and the location information or a weighted average of location information acquired from both the surroundings information and the location information with weighting factors depending on situations. Typically, the location information acquired from the GNSS receiver is higher in accuracy than the surroundings information acquired from the surroundings monitoring devices. Therefore, preferably, when using either one of the surroundings information and the location information depending on situations, the location information acquired from the GNSS receiver may be used preferentially as the second information. More specifically, for example, the error calculation unit 33 may be configured to, in situations where the GPS receiver 13 can not receive positioning signals, such as in roadway tunnels, acquire the second information from the camera sensor 11 or the radar sensor 12, and in situations where the GPS receiver 13 can receive positioning signals, acquire the positioning signals as the second information.

The error correction unit 34 is configured to correct for errors in the first information calculated by the error calculation unit 33. For example, the error correction unit 34 calculates physical quantities relating to the first information based on the second information. The error correction unit 34 corrects for errors in the first information such that the first information coincides with or approaches the calculated values based on the second information. More specifically, for example, the error correction unit 34 may calculate a wheel speed of the own vehicle based on a distance between an object detected by the camera sensor 11 and the own vehicle and use the calculated wheel speed as a corrected sensor reading from the wheel speed sensor 21 (included in the first information). For example, there may be errors in sensor readings from the wheel speed sensor 21 when a tire diameter is greater or less than its assumed value due to low air pressure of tires. In such a case, the error calculation unit 33 may calculate errors in sensor readings from the wheel speed sensor 21, and the error correction unit 34 may correct for the errors in the sensor readings. This configuration allows the location estimation unit 35 as described later to use more accurate corrected sensor readings from the wheel speed sensor 21.

The location estimation unit 35 is configured to estimate a current or a future location of the own vehicle based on the first information. The future location of the own vehicle may be estimated based on the current first information of the own vehicle or may be estimated according to a travel plan generated by of the ECU 30. If error correction made by the error correction unit 34 has been completed, the location estimation unit 35 estimates a location of the own vehicle based on corrected first information that is a corrected version of the first information. If error correction made by the error correction unit 34 has not been completed, the location estimation unit 35 estimates a location of the own vehicle based on uncorrected first information.

The location estimation unit 35 may be configured to estimate not only a current location and a future location of the own vehicle, but also a travel speed, an acceleration, a rotational speed and the like of the own vehicle. Predictive models for predicting such various parameters for the own vehicle may include, but are not limited to, a constant-speed and constant-acceleration model that assumes a constant speed and a constant acceleration, a constant-steering-angle model that assumes a constant steering angle, and a constant-rotational-speed model that assumes a constant rotational speed. An interacting multiple model (IMM) that takes into consideration more than one of these predictive models may be used.

The location estimation unit 35 may further be configured to filter the estimated location of the own vehicle. Filtering techniques for filtering the estimated value may include, but are not limited to, a Kalman filter, a particle filter and the like.

The process change unit 36 is configured to, when error correction of the first information has been completed by the error correction unit 34, change a process of a specific type of driving assistance performed by the driving assistance unit 37. Preferably, the process change unit 36 may change a process of the specific type of driving assistance in response to the accuracy of the location of the own vehicle estimated by the location estimation unit 35. The process change unit 36 is configured to, when error correction of the first information has not been completed by the error correction unit 34, set the process of driving assistance to a passive mode that suppresses performing driving assistance, and when error correction of the first information has been completed by the error correction unit 34, set the process of driving assistance to an active mode that relieves suppression of driving assistance implementation. Suppression of driving assistance implementation in the passive mode may be set in response to expected errors of the location of the own vehicle by the location estimation unit 35. In the present embodiment, the process of the specific type of driving assistance performed by the driving assistance unit 37 may be set to a passive mode until completion of error correction of the first information by the error correction unit 34. Upon completion of error correction of the first information by the error correction unit 34, the process of the specific type of driving assistance performed by the driving assistance unit 37 may be changed to an active mode. This enables more timely performing more proper driving assistance.

The process change unit 36 may adjust the degree of change in the process of the specific type of driving assistance in response to a specific parameter, such as a vehicle speed, a curve radius of a travel path or the like of the own vehicle, that can affect the expected error in the location of the own vehicle. When a degree of suppression of driving assistance implementation in the passive mode is changed according to the specific parameter that can affect the expected error in the location of the own vehicle, the process of the specific type of driving assistance may be changed in response to the specific parameter upon completion of error correction. This enables making a change to a process suitable for the accuracy of the estimated location of the own vehicle.

When the first information includes plural types of driving information, such as a wheel speed, a yaw rate and the like, the error calculation unit 33 may calculate an error in each type of driving information. The error correction unit 34 may correct for the error in each type of driving information. In this case, the process change unit 36 may be configured to increase the degree of change in the process of driving assistance as the total number of types of driving information for which error correction has been completed increases.

The driving assistance unit 37 is configured to perform own-vehicle driving assistance based on the location of the own vehicle estimated by the location estimation unit 35. The driving assistance unit 37 includes a collision avoidance unit 38, an automated driving unit 39, and an Adaptive Cruise Control (ACC) unit 40.

The collision avoidance unit 38, which serves as a Pre-Crash Safety (PCS) system, is configured to determine whether or not a collision is likely to occur between the own vehicle and an object around the own vehicle, and if determining that a collision is likely to occur between the own vehicle and an object around the own vehicle, perform collision avoidance control or pre-crash mitigation control. More specifically, based on a relative distance between the own vehicle and the object, the collision avoidance unit 38 calculates a predicted time to collision (TTC) between the own vehicle and the object, and to avoid a collision between the own vehicle and the object, determines whether to actuate the braking device 51, the steering device 53, the warning device 54 or the like by comparing the TIC and actuation timing, thereby avoiding the collision. The actuation timing is when the braking device 51, the steering device 53, the warning device 54 or the like should be actuated. The actuation timing may individually be set for each device to be actuated. The predicted time to collision is calculated based on a current location and a future location of the own vehicle estimated by the location estimation unit 35.

The automated driving unit 39 is configured to perform automated driving according to a travel plan or the like to perform automated parking. For example, the automated driving unit 39 may have a Lane Keeping Assist (LKA) function of keeping the own vehicle in an own-vehicle's lane by generating steering force in a direction that prevents the own vehicle from approaching a lane line of the own-vehicle's lane, and a Lane Change Assist (LCA) function of enabling an automated movement of the own vehicle to an adjacent lane.

The ACC unit 40 is configured as having an Adaptive Cruise Control (ACC) function of controlling a travel speed of the own vehicle so as to keep a target inter-vehicle distance between the own vehicle and a preceding vehicle by adjusting driving and braking force.

The type of driving assistance to be performed by the driving assistance unit 37, whose process is to be changed by the process change unit 36, may be driving assistance of controlling behaviors of the own vehicle based on a current location and a future location of the own vehicle, but is not limited to the types of driving assistance set forth above.

The process change unit 36 may be configured to adjust the degree or content of change in the process of driving assistance in response to the type of driving assistance. For example, the process change unit 36 may change, for each of types of driving assistance set forth above, such as collision avoidance control, automated driving control, ACC control and the like, the actuation timing, the actuation magnitude, and the actuation duration.

For example, in the case where driving assistance whose process is to be changed is collision avoidance control, the process change unit 36 may change the braking force magnitude from the braking device 51, the warning sound magnitude from the warning device 54, or display visibility of the display unit 55 (such as sizes, colors, or brightness).

For example, in the case where the type of driving assistance whose process is to be changed is automated driving, the process change unit 36 may change degrees of various types of control, such as accelerator control, brake control, steering control, and notification control, performed in response to a relative position between the own vehicle and the object.

For example, in the case where driving assistance whose process is to be changed is ACC control, the process change unit 36 may change acceleration and deceleration levels of the own vehicle, acceleration and deceleration timings of the own vehicle, the upper and lower limits of a separation distance and a separation time between the own vehicle and another vehicle traveling around the own vehicle. For any other type of driving assistance whose process is to be changed, the process change unit 36 may change timings, the magnitude, the duration and the like of driving assistance functions, such as warning, braking, steering and the like.

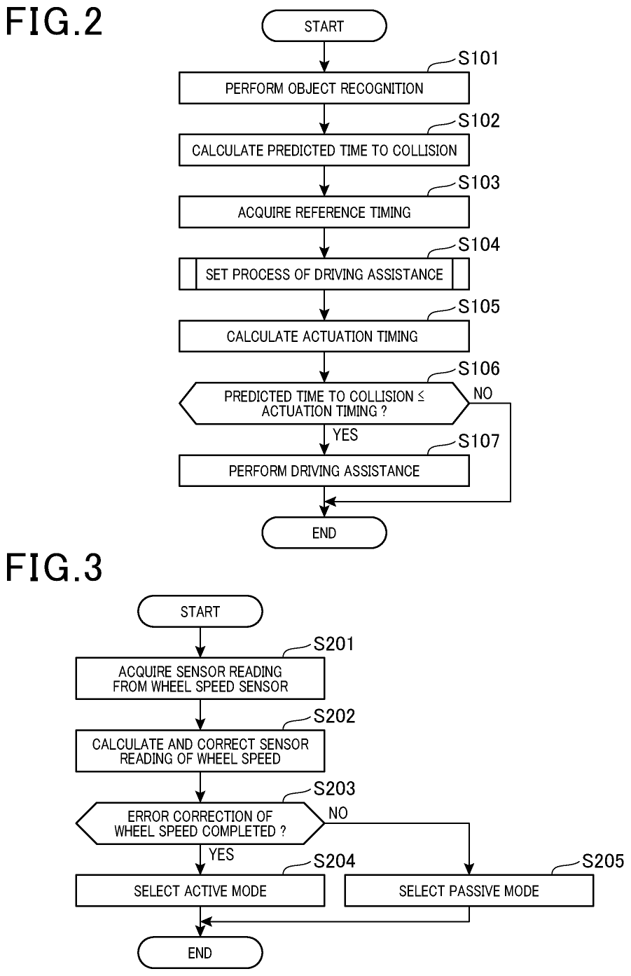

Regarding driving assistance control performed by the ECU 30, exemplary collision avoidance control performed by the collision avoidance unit 38 will now be described with reference to a flowchart of FIG. 2.

At step S101, the ECU 30 performs object recognition based on object sense information about objects around the own vehicle acquired from the camera sensor 11 and the radar sensor 12. The process flow then proceeds to step S102.

At step S102, the ECU 30 calculates a predicted time to collision for each of recognized objects around the own vehicle. The process flow then proceeds to step S103.

At step S103, the ECU 30 acquires a reference timing TC1 to actuate the controlled device unit 50, such as the braking device 51, the warning device 54 and the like, when performing collision avoidance control. This reference timing TC1 is predetermined for each object type and acquired from the memory of the ECU 30. The process flow proceeds to step S104.

At step S104, processing for setting a process of driving assistance shown in FIG. 3 is performed. At step S201, the ECU 30 acquires, as the first information, a sensor reading from the wheel speed sensor 21. The process flow then proceeds to step S202.

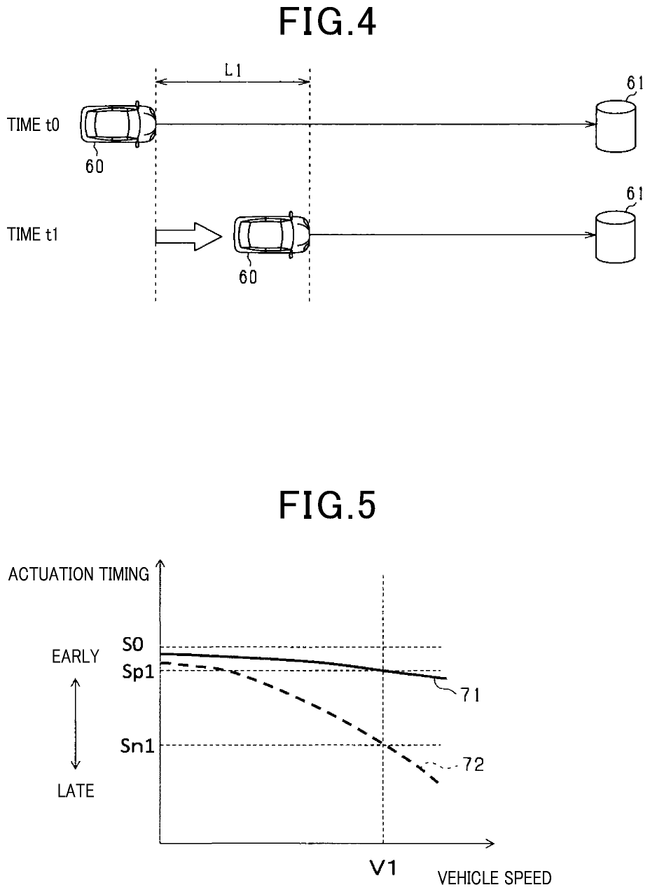

At step S202, the ECU 30 calculates and corrects for an error in the wheel speed sensor 21. More specifically, as shown in FIG. 4, the ECU 30 calculates a distance L1 distance travelled by the own vehicle 60 from time t0 to time t1 by calculating a change in a relative distance from the own vehicle 60 to a landmark 61 that is a stationary object located ahead of the own vehicle 60. This traveled distance L1 is second information. The ECU 30 calculates a wheel speed of the own vehicle 60 during a period of time from time t0 to time t1 using the traveled distance L1. The ECU 30 calculates a difference between the calculated wheel speed and the sensor reading acquired from the wheel speed sensor 21 during a period of time from time t0 to time t1. This calculated difference is an error P1 in the wheel speed acquired from the wheel speed sensor 21 during a period of time from time t0 to time t1. This error is an error in the first information.

For error correction, at step S202, the ECU 30 calculates based on the error P1 in the sensor reading from the wheel speed sensor 21, calculates a correction amount Q1 of the sensor reading from the wheel speed sensor 21, and then corrects sensor readings sequentially acquired from the wheel speed sensor 21 with the correction amount Q1.

At step S203, the ECU 30 determines whether or not correction for an error in the wheel speed sensor 21 performed at step S202 has been completed. If such error correction has been completed (the “YES” branch of step S203), then the process flow proceeds to step S204. At step S204, the ECU 30 selects an active mode. If such error correction has not been completed (the “NO” branch of step S203), then the process flow proceeds to step S205. At step S205, the ECU 30 selects a passive mode.

FIG. 5 illustrates a relationship between the actuation timing (vertical axis) and the vehicle speed of the own vehicle (horizontal axis) for each of the active mode and the passive mode. In FIG. 5, S0 represents the reference timing S0 that is constant with respect to the vehicle speed. The continuous line 71 indicates the actuation timing in the active mode. The actuation timing in the active mode is delayed as the vehicle speed V1 increases. The broken line 72 indicates the actuation timing in the passive mode. The actuation timing in the passive mode is delayed as the vehicle speed V1 increases, where the actuation timing is more delayed in the passive mode than in the active mode. That is, the slope of the broken line 72 is greater than that of the continuous line 71. For example, at the vehicle speed V1, the actuation timing in the active mode is Sp1, and the actuation timing in the passive mode is Sn1. Regarding the accuracy of the first information, errors in the first information tend to increase as the vehicle speed increases. Therefore, in the passive mode, the actuation timing is delayed as the vehicle speed increases, thereby suppressing implementation of collision avoidance control. In the active mode, suppression of collision avoidance control implementation in the passive mode is relaxed. Therefore, the actuation timing Sp1 in the active mode is set closer to the reference timing S0 than the actuation timing Sn1 in the passive mode.

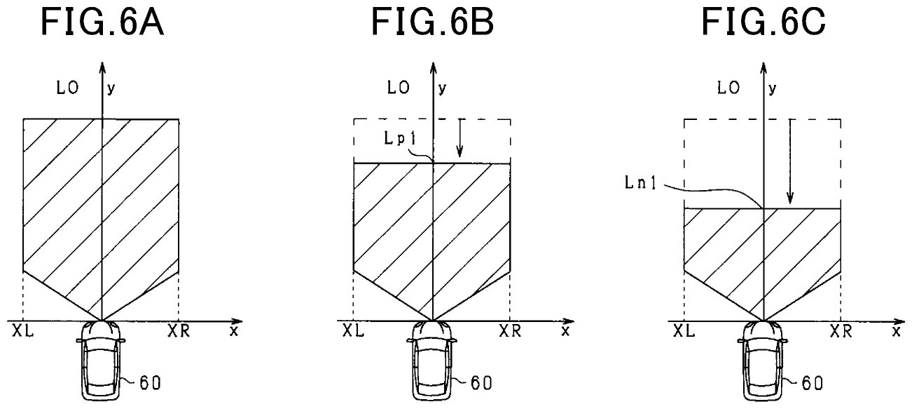

Delaying the actuation timing for a preceding vehicle for which collision avoidance control is to be performed will now be described with reference with FIGS. 6A-6C. More specifically, as shown in FIG. 6A, an actuation zone for the reference timing is defined by a forward edge position L0, a rightward edge position XR, and a leftward edge position XL. That is, if the preceding vehicle enters this actuation zone, collision avoidance control will be performed. The rightward edge position XR and the leftward edge position XL may be predefined for each object type to be monitored.

In the passive mode, as shown in FIG. 6C, the forward edge position Ln1 is set closer to the own vehicle 60 than the forward edge position L0. This setting narrows the actuation zone in the forward direction as compared with the actuation zone defined by the rightward edge position XR, the leftward edge position XL, and the forward edge position L0 as shown in FIG. 6A. That is, if the preceding vehicle is located at the forward edge position L0, the collision avoidance control will not be performed. If the preceding vehicle approaches the own vehicle 60 to reach the forward edge position Ln1, the collision avoidance control will be performed. Narrowing the actuation zone in the forward direction allows the actuation timing to be delayed, which can prevent the collision avoidance control implementation until the preceding vehicle further approaches the own vehicle 60.

In the active mode, as shown in FIG. 6B, the forward edge position Lp1 is set further away from the own vehicle 60 than the forward edge position Ln1 in the passive mode. This setting reduces the actuation timing delay in the passive mode and thus allows the actuation timing to be advanced to the actuation timing Sp1 that is closer to the reference timing S0 than the actuation timing Sn1 in the passive mode.

After selection of the mode of collision avoidance control at step S204 or step S205, the processing for setting a process of driving assistance at step S104 shown in FIG. 3 ends. The process flow then proceeds to step S105.

At step S105, in response to the mode selected at step S104, the ECU 30 calculates an actuation timing. In the active mode, the actuation timing is calculated to be an actuation timing closer to the reference timing than in the passive mode. In the passive mode, as described above, the actuation timing is delayed by a predetermined amount of time from the reference timing. More specifically, when the own vehicle is traveling at the vehicle speed V1, the actuation timing is set to the actuation timing Sp1 in the active mode or the actuation timing Sn1 in the passive mode.

After calculation of the actuation timing at step S105, the process flow proceeds to at step S106. At step S106, the ECU 30 compares the predicted time to collision and the actuation timing. If the predicted time to collision is equal to or less than the actuation timing (the “YES” branch of step S106), the process flow proceeds to step S107, where the ECU 30 performs collision avoidance control as driving assistance control. Thereafter, the process flow ends. More specifically, for example, the ECU 30 transmits a signal to actuate the braking device 51 or the like. Thereafter, the process flow ends. If the predicted time to collision exceeds the actuation timing (the “NO” branch of step S106), the process flow ends without performing collision avoidance control.

In the first embodiment set forth above, a location of the own vehicle is estimated using sensor readings (as the first information) corrected for errors from the wheel speed sensor 21, which enabling performing driving assistance based on the location of the own vehicle. For example, in cases where a tire diameter is greater or less than its assumed value due to low air pressure of tires, there may be errors in sensor readings from the wheel speed sensor 21. Errors in the sensor readings from the wheel speed sensor 21 are calculated at step S202 and the sensor readings from the wheel speed sensor 21 are corrected for the calculated errors, which allows the location of the own vehicle to be estimated using more accurate corrected sensor readings from the wheel speed sensor 21.

Sensor readings from the wheel speed sensor 21 are used as the first information, and surroundings information of the own vehicle acquired by the radar sensor 12 is used as the second information, which enables accurately correcting the sensor readings from the wheel speed sensor 21.

Unless error correction of the sensor readings from the wheel speed sensor 21 is completed, the passive mode in which driving assistance implementation is suppressed is selected taking into consideration expected errors in various sensed information including the location of the own vehicle. If error correction of the sensor readings from the wheel speed sensor 21 is completed, the active mode is selected as the location of the own vehicle is accurately estimated, which can relax suppression of driving assistance implementation. This enables timely performing driving assistance.

Particularly, in the first embodiment, in the case where the type of driving assistance is collision avoidance control, a too late or too early actuation timing for the braking devices 51 may make it difficult to ensure collision safety and driving safety. The configuration of the first embodiment enables increasing the estimation accuracy of the location of the own vehicle and timely actuating the braking device 51, which can more reliably ensure collision safety and driving safety.

### Second Embodiment

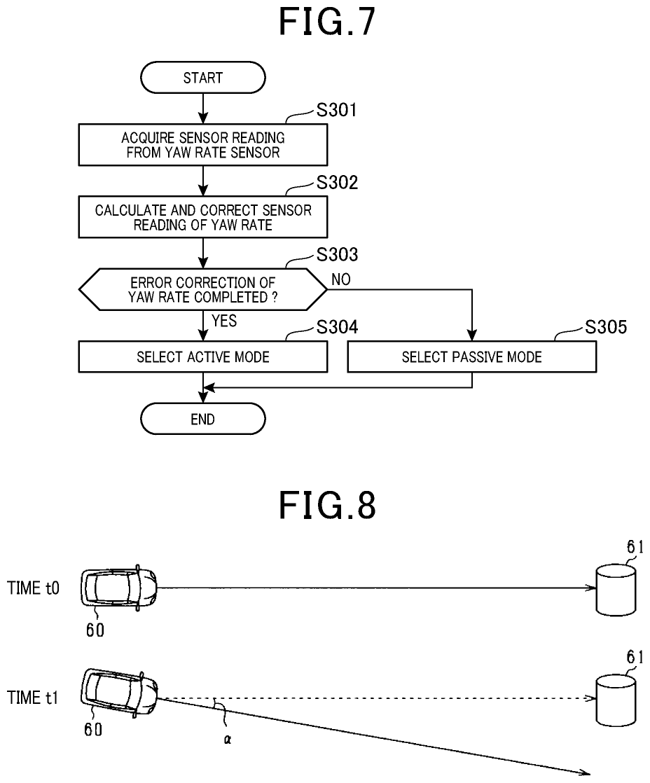

In driving assistance control performed by the ECU 30 shown in FIG. 2 according to a second embodiment, processing for setting a process of driving assistance shown in FIG. 7 is performed. Respective steps shown in FIG. 2 are similar to those of the first embodiment and thus will not be redundantly described.

At step S104, processing for setting a process of driving assistance shown in FIG. 7 is performed. At step S301, the ECU 30 acquires, as the first information, a sensor reading from the yaw rate sensor 22. The process flow then proceeds to step S302.

At step S302, the ECU 30 calculates and corrects for an error in the sensor reading from the yaw rate sensor 22. More specifically, as shown in FIG. 8, the ECU 30 calculates a change in a left-right direction of the own vehicle 60 relative to the forward direction from time t0 to time t1 by calculating a change in a direction of the own vehicle relative to a landmark 61 that is a stationary object located ahead of the own vehicle 60. This change in a yaw angle α is second information. The ECU 30 calculates a yaw rate (a change per unit time in yaw angle) of the own vehicle 60 during a period of time from time t0 to time t1 using the change in the yaw angle α. The ECU 30 calculates a difference between the calculated yaw rate and the sensor reading acquired from the yaw rate sensor 22 during a period of time from time t0 to time t1. This calculated difference is an error P2 in the yaw rate acquired from the yaw rate sensor 22. This error is an error in the first information.

For error correction, the ECU 30 calculates a correction amount Q2 of the sensor reading from the yaw rate sensor 22 based on the error P2 in the sensor reading from the yaw rate sensor 22 calculated at step S302, corrects the sensor readings sequentially acquired from the yaw rate sensor 22 with the correction amount Q2.

At step S303, the ECU 30 determines whether or not correction for an error in the yaw rate sensor 22 at step S302 has been completed. If such error correction has been completed (the “YES” branch of step S303), then the process flow proceeds to step S304. At step S304, the ECU 30 selects an active mode. If such error correction has not been completed (the “NO” branch of step S303), then the process flow proceeds to step S305. At step S305, the ECU 30 selects a passive mode.

In the second embodiment set forth above, a location of the own vehicle is estimated using sensor readings (as the first information) corrected for errors from the yaw rate sensor 22, which enables performing driving assistance based on more accurate estimated location of the own vehicle. In addition, sensor readings from the yaw rate sensor 22 are used as the first information, and surroundings information of the own vehicle acquired by the camera sensor 11 is used as the second information, which enables accurately correcting the sensor readings from the yaw rate sensor 22.

### Third Embodiment

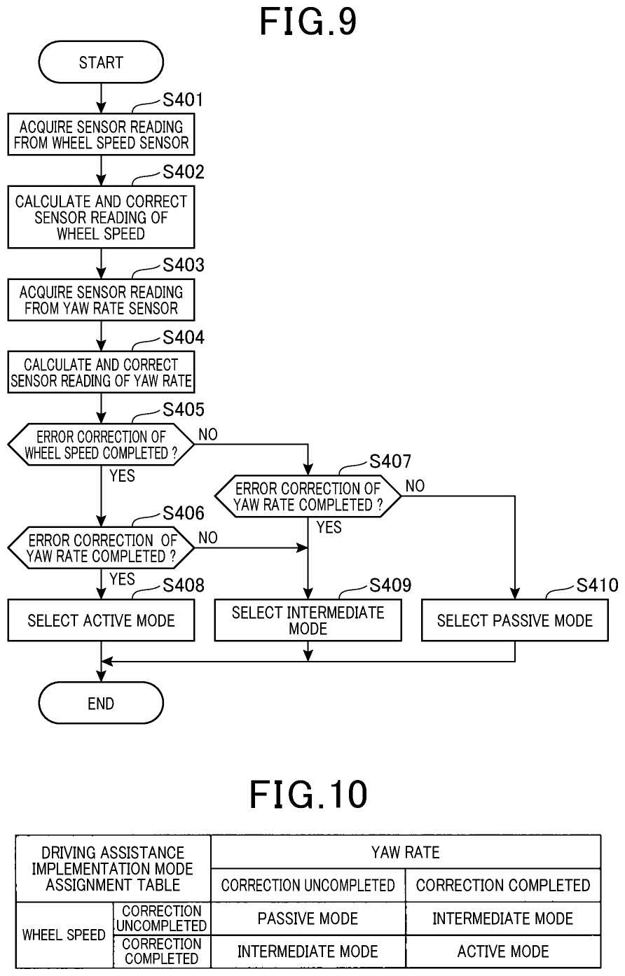

In driving assistance control performed by the ECU 30 shown in FIG. 2 according to a third embodiment, processing for setting a process of driving assistance shown in FIG. 9 is performed. Respective steps shown in FIG. 2 are similar to those of the first embodiment and thus will not be redundantly described.

At step S104, processing for setting a process of driving assistance shown in FIG. 9 is performed. At steps S401 and S402, similar processes to those of steps S201 and S202 shown in FIG. 3 are performed. Errors in sensor readings acquired from the wheel speed sensor 21 as the first information are calculated, and the sensor readings are corrected using surroundings information acquired from the camera sensor 11 as the second information. At steps S403 and S404, similar processes to those of steps S301 and S302 shown in FIG. 7 are performed. Errors in sensor readings acquired from the yaw rate sensor 22 as the first information are calculated, and the sensor readings are corrected using surroundings information acquired from the radar sensor 12 as the second information. Thereafter, the process flow proceeds to step S405.

At steps S405 through S410, as shown in FIG. 10, mode selection for collision avoidance control is performed depending on whether or not correction for errors in sensor readings of the wheel speed and the yaw rate acquired from the sensors 21, 22 has been completed. An intermediate mode is a mode between the passive mode and the active mode. That is, in the intermediate mode, suppression of driving assistance implementation is less relaxed than in the active mode, but is more relaxed than in the passive mode. The actuation timing in the intermediate mode is set between the continuous line 71 and the broken line 72 as shown in FIG. 5. Since suppression of driving assistance implementation is also relaxed in the intermediate mode, the intermediate mode may be an example of the active mode of driving assistance. The number of modes to be selected is not limited to three (i.e., the active mode, the intermediate mode, and the passive mode), but may be two (the active mode and the passive mode) or greater than three. For example, given three or more modes having different relaxation levels, a mode in which suppression of driving assistance implementation is more relaxed may be selected as the extent of correction for errors in the first information or the accuracy of corrected first information increases.

At step S405, using similar processing and techniques used at step S203, the ECU 30 determines whether or not correction for errors in the sensor readings from the wheel speed sensor 21 has been completed. If correction for errors in the sensor readings from the wheel speed sensor 21 has been completed, then the process flow proceeds to step S406. If error correction of the sensor readings from the wheel speed sensor 21 has not been completed, then the process flow proceeds to step S407.

At step S406, using similar processing and techniques used at step S303, the ECU 30 determines whether or not correction for errors in the sensor readings from the yaw rate sensor 22 has been completed. If correction for errors in the sensor readings from the yaw rate sensor 22 has been completed, then the process flow proceeds to step S408, where the ECU 30 selects the active mode. If correction for errors in the sensor readings from the yaw rate sensor 22 has not been completed, then the process flow proceeds to step S409, where the ECU 30 selects the intermediate mode.

At step S407, using similar processing and technique used at steps S303 and S406, the ECU 30 determines whether or not correction for errors in the sensor readings from the yaw rate sensor 22 has been completed. If correction for errors in the sensor readings from the yaw rate sensor 22 has been completed, then the process flow proceeds to step S409, where the ECU 30 selects the intermediate mode. If correction for errors in the sensor readings from the yaw rate sensor 22 has not been completed, then the process flow proceeds to step S410, where the ECU 30 selects the passive mode.

According to the third embodiment set forth above, a location of the own vehicle can be estimated using plural types of driving information as the first information (i.e., sensor readings from the wheel speed sensor 21 and sensor readings from the yaw rate sensor 22) corrected for errors, which enables performing driving assistance based on more accurate estimated location of the own vehicle.

In addition, according to the third embodiment set forth above, a degree of change in the process of driving assistance is increased as the number of types of sensor readings acquired from plural types of sensors included in the driving state sense unit 20 for which error correction has been completed increases. More specifically, if both of correction for errors in sensor readings of the wheel speed and correction for errors in sensor readings of the yaw rate have been completed, the active mode is selected. If only one of correction for errors in sensor readings of the wheel speed and correction for errors in sensor readings of the yaw rate has been completed, the intermediate mode is selected. If neither correction for errors in sensor readings of the wheel speed nor correction for errors in sensor readings of the yaw rate has been completed, the passive mode is selected. This enables a change to a process suitable for the accuracy of the estimated location of the own vehicle.

### Fourth Embodiment

According to the third embodiment set forth above, given a plurality of types of driving information acquired as the first information, a degree of change in the process of driving assistance is increased as the total number of types of driving information for which error correction has been completed increases. In a fourth embodiment, a degree of change in the process of driving assistance is adjusted in response to a specific parameter that can affect the expected error in the location of the own vehicle. Such a parameter may be a vehicle speed of the own vehicle, a curve radius of a travel path of the own vehicle or the like.

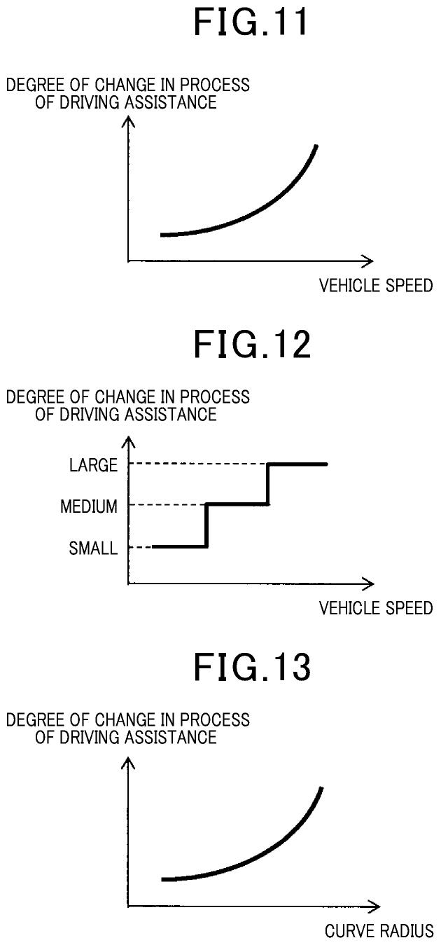

More specifically, for example, as shown in FIGS. 11 and 12, the degree of change in the process of driving assistance may be increased as the vehicle speed increases. For example, as shown in FIG. 11, the degree of change in the process of driving assistance may be monotonically increased in a linear or curved manner as the vehicle speed increases. As shown in FIG. 12, the degree of change in the process of driving assistance may be increased in a staircase manner as the vehicle speed increases. Similarly, as shown in FIG. 13, the degree of change in the process of driving assistance may be increased as the curve radius increases. The curve radius may be changed in a staircase manner.

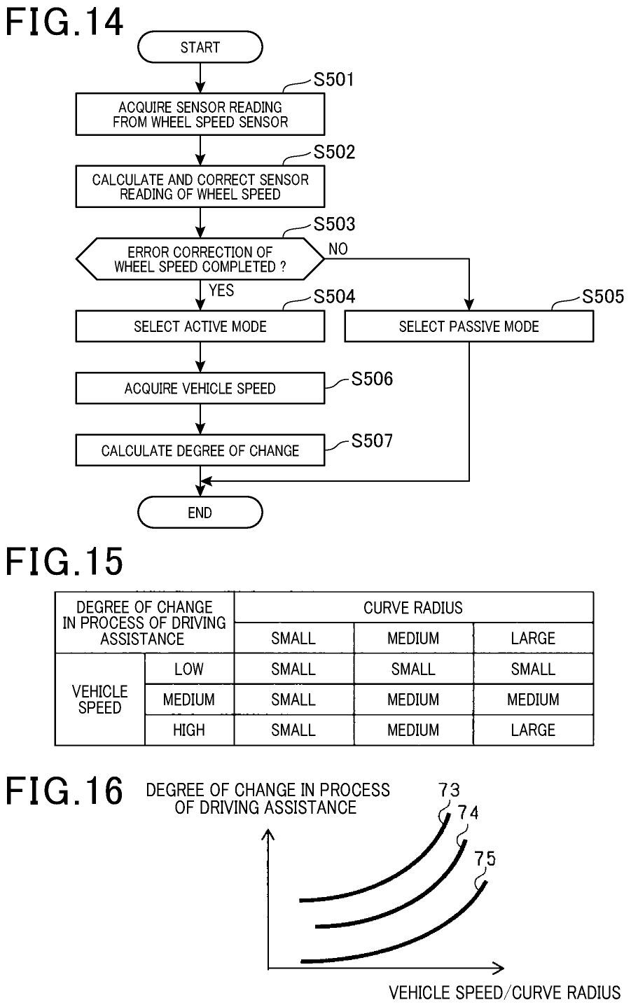

In driving assistance control performed by the ECU 30 shown in FIG. 2, processing for setting a process of driving assistance shown in FIG. 14 is performed. Respective steps shown in FIG. 2 are similar to those of the first embodiment and thus will not be redundantly described. Steps S501 to S503, and S505 shown in FIG. 14 are similar to steps S201 to S203, and S205 shown in FIG. 3 and thus will not be redundantly described.

After the active mode is selected at step S504, the process flow proceeds to step S506, where the ECU 30 acquires a vehicle speed of the own vehicle. The vehicle speed of the own vehicle can be calculated based on corrected first information including a corrected version of the sensor reading from the wheel speed sensor 21. Thereafter, the process flow proceeds to step S507.

At step S507, using a relationship shown in FIG. 11 or 12, the ECU 30 determines a degree of change in the process of driving assistance based on the vehicle speed calculated at step S506. For example, when the relationship shown in FIG. 12 is used, the ECU 30 sets the degree of change in the process of driving assistance to “LOW” if the vehicle speed is within a relatively low speed range, sets the degree of change in the process of driving assistance to “MEDIUM” if the vehicle speed is within a medium speed range, and sets the degree of change in the process of driving assistance to “HIGH” if the vehicle speed is within a relatively high speed range. Thereafter, the process flow ends.

As above, according to the fourth embodiment, in the active mode, the degree of change in the process of driving assistance is adjusted in response to the specific parameter (a vehicle speed of the own vehicle, a curve radius of a travel path of the own vehicle or the like) that can affect the expected error in the location of the own vehicle. With this configuration, the active mode can be set such that the degree of suppression of driving assistance implementation in the passive mode is properly relaxed. For example, as shown in FIG. 5, the expected error in the location of the own vehicle increases as the vehicle speed increases. A delay of the actuation timing in the passive mode that suppresses driving assistance implementation increases as the expected error increases. Thus, the degree of relaxation of the delay when the active mode is selected is increased as the vehicle speed increases, which allows the actuation timing to be set properly close to the reference timing in the active mode.

As shown in FIG. 15, the degree of change in the process of driving assistance is adjusted in response to plural specific parameters (e.g., a vehicle speed of the own vehicle and a curve radius of a travel path of the own vehicle) that can affect the expected error in the location of the own vehicle. More specifically, if the vehicle speed is within a relatively low speed range or if the curve radius is within a relatively small radius range, the degree of change in the process of driving assistance may be set to “LOW”. If the vehicle speed is within a medium speed range or if the curve radius is within a medium radius range, the degree of change in the process of driving assistance may be set to “MEDIUM”. If the vehicle speed is within a relatively high speed range and if the curve radius is within a relatively large radius range, the degree of change in the process of driving assistance may be set to “HIGH”.

Modifications

In the embodiments set forth above, the process of collision avoidance control that is one of types of driving assistance performed by the driving assistance unit 37 is changed. In some alternative embodiments, the process change unit 36 may arbitrarily change a process of any one of the types of driving assistance performed based on a location of the own vehicle estimated by the location estimation unit 35 in the driving assistance unit 37. For example, for each of LKA control, LCA control performed by the automated driving unit 39, Adaptive Cruise Control (ACC) performed by the ACC unit 40, the process of driving assistance may be changed. The process change unit 36 may properly select a content or type of driving assistance whose process is to be changed based on the vehicle information of the own vehicle, the surroundings information of the own vehicle, and information about a travel path of the own vehicle.

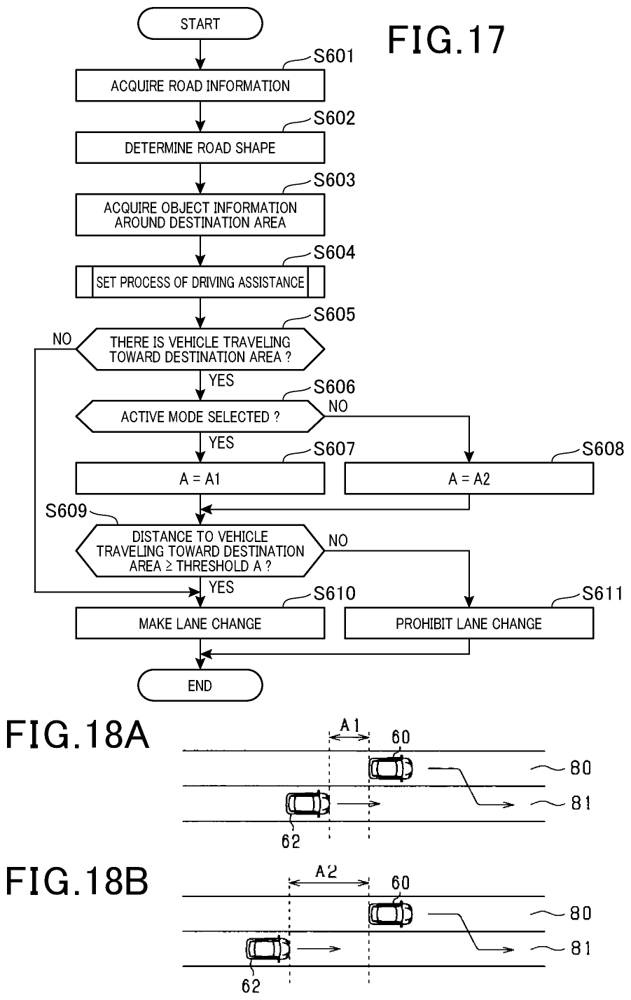

For example, for LCA control performed by the ECU 30, changing the process of driving assistance will now be described with reference to FIG. 17.

At step S601, the ECU 30 acquires road information (that is information about a road on which the own vehicle is traveling) from surroundings monitoring devices, such as the camera sensor 11, the radar sensor 12 and the like. At step S602, the ECU 30 determines a road shape from the road information. The process flow then proceeds to step S603.

At step S603, based on the road shape determined at step 602, the ECU 30 determines a destination area to which the own vehicle will make a lane change and acquires object information around the destination area.

At step S604, as in FIG. 2, the ECU 30 performs processing for setting a process of driving assistance. More specifically, processing for setting a process of driving assistance shown in any one of FIGS. 3, 7, 9, and 14 may be applicable. In the following, it is assumed that the active mode or the passive mode has been selected using the processing for setting a process of driving assistance shown in FIG. 3.

After execution of step S604, the process flow proceeds to step S605, where the ECU 30 determines whether or not there is another vehicle traveling toward the destination area. More specifically, the ECU 30 acquires information about the destination area and its surrounding area from the camera sensor 11 or the like. At step S605, if there is another vehicle traveling toward the destination area, the process flow proceeds to step S606. If there is not another vehicle traveling toward the destination area, the process flow proceeds to step S610, where lane change control is performed.

At step S606, the ECU 30 determines whether or not the active mode has been selected at step S604. If the active mode has been selected, the ECU 30 sets an LCA threshold A used to determine whether or not the lane change is allowed to be made to A1. If the passive mode has been selected, the ECU 30 sets an LCA threshold A used to determine whether or not the lane change is allowed to be made to A2 (A1<A2).

The process flow proceeds from step S607 or S608 to step S609. At step S609, the ECU 30 determines whether or not a distance X between the vehicle traveling toward the destination area and the own vehicle is equal to or greater than the LCA threshold A. The LCA threshold A is set to a value such that the lane change can be made in safety. If X≥A, the process flow proceeds to step S610, where the lane change is made. If X<A, the process flow proceeds to step S611, where the lane change is prohibited. The process flow ends after step S610, S611.

FIGS. 18A and 18B illustrate situations where the own vehicle 60 traveling in a lane 80 will make a lane change to an adjacent lane 81 ahead of a vehicle 62. Each of the LCA thresholds A1, A2 is a minimum distance (a distance between the vehicle 62 and the own vehicle in the travel direction), at a distance greater than which the own vehicle 60 is allowed to make a lane change from the lane 80 to a lane 81. In the active mode, as shown in FIG. 18A, if a distance X between the vehicle 62 and the own vehicle 60 is equal to or greater than the LCA threshold A1 (X≥A1), the own vehicle 60 is allowed to make the lane change. In the passive mode, as shown in FIG. 18B, if a distance X between the vehicle 62 and the own vehicle 60 is equal to or greater than the LCA threshold A2 (X≥A2), the own vehicle 60 is more readily permitted to make the lane change. In the active mode, the lane change is more readily permitted than in the passive mode. In such a case, at step S604, errors in the first information (i.e., the wheel speed) acquired from the wheel speed sensor 21 have been corrected for by steps S201 to S203 shown in FIG. 3, which enables making a lane change in safety even if, as shown in 8A, the vehicle 62 is relatively close to the own vehicle. This can reduce situations where a lane change is prohibited, thereby enabling a smoother lane change to be made.

Also for LKA control, ACC control, and automated parking control, when error correction has been completed by the error correction unit 34, the process change unit 36 changes a process of driving assistance to relax suppression of driving assistance implementation taking into account expected error in the location of the own vehicle calculated by the location estimation unit 35. For example, in ACC control, the own vehicle accelerates and deaccelerates to keep a target inter-vehicle distance B between the own vehicle and another vehicle traveling ahead of the own vehicle. In the active mode, the target inter-vehicle distance B is set to a small value (e.g., B=B1). In the passive mode, the target inter-vehicle distance B is set to a large value (e.g., B=B2>B1). In the active mode, the first information is corrected for errors and ACC control is performed based on the highly accurate estimated location of the own vehicle. This can achieve safer driving even if the target inter-vehicle distance is set to a smaller value B1.

In automated parking control, when the own vehicle is moved to a parking space, obstacles, such as a car stop, a parked vehicle and the like, and white lines demarcating the parking place, are recognized and the own vehicle is controlled to move to the parking space while keeping a distance C to each obstacle or each white line. In the active mode, the distance C to each obstacle or each white line is set to a small value (e.g., C=C1). In the passive mode, the distance C to each obstacle or each white line is set to a large value (C=C2>C1). In the active mode, even if the distance C to each obstacle or each white line is set to a smaller value, i.e., C=C1, the first information is corrected for errors and thus the own vehicle is controlled to move based on the highly accurate estimated location of the own vehicle. This can achieve automated parking in safety. This can guide the own vehicle to the parking place with ability to turn in a small radius, which can complete reliable and rapid automated parking.

In addition, the degree of change in the process of driving assistance to be made by the process change unit 36 may be adjusted in response to a type of driving assistance whose process is to be changed. For example, as shown in FIG. 16, the degree of change in the process of driving assistance may be set relatively high as indicated by the continuous line 73 in control performed by the collision avoidance unit 38. The degree of change in the process of driving assistance may be set relatively low as indicated by the continuous line 75 in driving assistance performed by the automated driving unit 39. In Adaptive Cruise Control (ACC) performed by the ACC unit 40, the degree of change in the process of driving assistance may be set medium as indicated by the continuous line 74 between the continuous line 73 and the continuous line 75.

For each type of driving assistance, relationships between a plurality of parameters that can affect the expected error in the location of the own vehicle and the degree of change in the process of driving assistance may be stored in the ECU 30 in the form of data tables as shown in FIG. 15, equations or the like. For each type of driving assistance whose process is to be changed, the “HIGH”, “MEDIUM”, and “LOW” ranges of parameters for classifying the degree of change in the process of driving assistance may be changed. For example, the low speed range, the medium speed range, and the high speed range of the vehicle speed, and the large radius range, the medium radius range, and the small radius range of the curve radius as described with reference to FIG. 15 may be changed depending on in which one of the types of driving assistance performed by the collision avoidance unit 38, the automated driving unit 39, and the ACC unit 40 a process of driving assistance is to be changed.

The embodiments described above can provide the following advantages.

In the ECU 30, the first information is corrected for errors by the error calculation unit 33 and the error correction unit 34 based on the first information and the second information, such that corrected first information can be acquired. The location estimation unit 35 can estimate the location of the own vehicle using the corrected first information, which enables more accurately estimating the location of the own vehicle. If error correction performed by the error correction unit 34 is completed, the process change unit 36 changes a process of at least one type of driving assistance (e.g., collision avoidance control and the like) to be performed by the driving assistance unit 37. This enables performing proper driving assistance based on the accurate corrected location of the own vehicle.

The process change unit 36 is configured to, unless error correction of the first information performed by the error correction unit 34 is completed, set the process of the specific type of driving assistance to a passive mode that suppresses driving assistance implementation in response to an expected error in the location of the own vehicle estimated by the location estimation unit 35. The process change unit 36 is configured to, if error correction of the first information performed by the error correction unit is completed, change the process of the specific type of driving assistance to an active mode that relaxes suppression of driving assistance implementation in the passive mode. The accuracy of the location of the own vehicle estimated by the location estimation unit 35 increases in response to error correction of the first information being completed. Thus, changing the process of the specific type of driving assistance to the active mode in response to such increased accuracy enables timely and proper driving assistance implementation.

The process change unit 36 may be configured to, in response to at least one parameter that can affect an expected error in the location of the own vehicle, adjust a degree of change in the process of the specific type of driving assistance. For example, to suppress driving assistance implementation in response to an expected error in the location of the own vehicle, an amount of suppression may be changed in response to a specific parameter that can affect an expected error in the location of the own vehicle. Adjusting the degree of change in the process of the specific type of driving assistance in such a manner enables properly decreasing the amount of suppression.

In cases where the first information includes plural types of driving information detected by plural types of sensors included in the driving state sense unit 20, the error correction unit 34 is configured to, for each type of driving information, correct for errors in the first information calculated by the error calculation unit 33, and the process change unit 36 is configured to increase the degree of change in the process of driving assistance as the total number of types of driving information for which error correction is completed increases. Thus, acquiring plural types of driving information as first information, and calculating and correcting for errors in the first information, enables adjusting the degree of change in the process of driving assistance.

The process change unit 36 may be configured to, in response to a specific type of driving assistance to be performed by the driving assistance unit 37, adjust a degree of change in the process of the type of driving assistance. With this configuration, in response to a type of driving assistance whose process is to be changed, the process of the type of driving assistance can be properly changed.

What is claimed is:

1. An apparatus for assisting driving a vehicle, comprising:
a first information acquisition unit configured to acquire driving information representing a driving state of the vehicle as first information;
a second information acquisition unit configured to acquire at least one of surroundings information and external location information of the vehicle as second information;
an error calculation unit configured to calculate errors in the first information based on the first information and the second information;
an error correction unit configured to correct for the errors in the first information calculated by the error calculation unit;
a location estimation unit configured to, if error correction performed by the error correction unit is completed, estimate a location of the vehicle based on the first information corrected for the errors;
a driving assistance unit configured to perform driving assistance for the vehicle based on the location of the vehicle estimated by the location estimation unit; and
a process change unit configured to, if error correction performed by the error correction unit is completed, change a process of a specific type of driving assistance to be performed by the driving assistance unit.

2. The apparatus according to claim 1, wherein
the first information includes driving information acquired from at least one of a wheel speed sensor, a yaw rate sensor, a steering angle sensor, an acceleration sensor, and a gyro sensor.

3. The apparatus according to claim 1, wherein
the second information includes at least one of surroundings information acquired from a surroundings monitoring device installed in the vehicle and location information acquired from a GNSS receiver installed in the vehicle, and
the surroundings monitoring device includes at least one of a camera sensor, a radar sensor, an ultrasonic sensor, and a light detection and ranging (LIDAR).

4. The apparatus according to claim 1, wherein
the process change unit is configured to change a process of collision avoidance control performed by the driving assistance unit.

5. The apparatus according to claim 1, wherein
the first information includes sensor readings acquired from a wheel speed sensor mounted to the vehicle, and
the second information includes surroundings information around the vehicle acquired from a radar sensor mounted to the vehicle.

6. The apparatus according to claim 1, wherein
the first information includes sensor readings acquired from a yaw rate sensor mounted to the vehicle, and
the second information includes surroundings information around the vehicle acquired from a camera sensor mounted to the vehicle.

7. The apparatus according to claim 1, wherein
the process change unit is configured to, unless error correction performed by the error correction unit is completed, set the process of the specific type of driving assistance to a passive mode that suppresses driving assistance implementation in response to an expected error in the location of the vehicle estimated by the location estimation unit, and if error correction performed by the error correction unit is completed, change the process of the specific type of driving assistance to an active mode that relaxes suppression of driving assistance implementation.

8. The apparatus according to claim 1, wherein
the process change unit is configured to, in response to at least one parameter that can affect an expected error in the location of the vehicle, adjust a degree of change in the process of the specific type of driving assistance.

9. The apparatus according to claim 1, wherein
the first information includes plural types of driving information,
the error calculation unit is configured to, for each type of driving information, calculate an error in the first information,
the error correction unit is configured to, for each type of driving information, correct for the error in the first information calculated by the error calculation unit, and
the process change unit is configured to increase the degree of change in the process of the specific type of driving assistance as a total number of types of driving information for which error correction is completed increases.

10. The apparatus according to claim 1, wherein
the process change unit is configured to, in response to the specific type of driving assistance, adjust a degree of change in process of the specific type of driving assistance.

11. The apparatus according to claim 1, wherein
the specific type of driving assistance is one of collision avoidance control, automated driving control, and adaptive cruise control (ACC).

12. The apparatus according to claim 1, wherein
the process change unit is configured to, if error correction performed by the error correction unit is completed, change a timing, a magnitude, and a duration of the specific type of collision avoidance control.

13. An apparatus for assisting driving a vehicle, comprising:
a first information acquisition unit, performed by an electronic control unit, configured to acquire driving information representing a driving state of the vehicle as first information;
a second information acquisition unit, performed by an electronic control unit, configured to acquire at least one of surroundings information and external location information of the vehicle as second information;
an error calculation unit, performed by an electronic control unit, configured to calculate errors in the first information based on the first information and the second information;
an error correction unit, performed by an electronic control unit, configured to correct for the errors in the first information calculated by the error calculation unit;
a location estimation unit, performed by an electronic control unit, configured to, if error correction performed by the error correction unit is completed, estimate a location of the vehicle based on the first information corrected for the errors;
a driving assistance unit, performed by an electronic control unit, configured to perform driving assistance for the vehicle based on the location of the vehicle estimated by the location estimation unit; and
a process change unit, performed by an electronic control unit, configured to, if error correction performed by the error correction unit is completed, change a process of a specific type of driving assistance to be performed by the driving assistance unit.

14. A method for assisting driving a vehicle, comprising:
acquiring driving information representing a driving state of the vehicle as first information;
acquiring at least one of surroundings information and external location information of the vehicle as second information;
calculating errors in the first information based on the first information and the second information;
correcting for the calculated errors in the first information;
estimating a location of the vehicle based on the first information corrected for the errors if error correction of the first information is completed;
performing driving assistance for the vehicle based on the estimated location of the vehicle; and
changing a process of a specific type of driving assistance if error correction of the first information is completed.
